(19) United States
(12) Patent Application Publication
(10) Pub. No.: US 2008/0037164 A1
(43) Pub. Date: Feb. 14, 2008

(54) ADAPTIVE SPINDLE MOTOR STARTUP METHOD AND DISK DRIVE USING THE SAME

(75) Inventors: Kyoung-whan OH, Seoul (KR); Sang-hoon Chu, Yongin-si (KR); Nam-guk Kim, Anyang-si (KR); Cheol-hoon Park, Yongin-si (KR); Su-hwan Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/769,060

(22) Filed: Jun. 27, 2007

(30) Foreign Application Priority Data
Aug. 8, 2006 (KR) 2006-74656

(51) Int. Cl. G11B 17/02

(52) U.S. Cl. 360/99.08

(57) ABSTRACT

An adaptive spindle motor startup method includes applying an internal driving voltage to a disk drive, sensing an internal temperature of the disk drive, and controlling the startup of a spindle motor by adjusting a startup factor related to a startup current applied to the spindle motor corresponding to the sensed temperature. Thus, the delay of time to reach a target rotation rate is prevented in the spindle motor in an extreme environment, for example at temperatures lower or higher than 25° C. The overall startup time is efficiently optimized through the improvement of the startup method of the spindle motor.

### CROSS-REFERENCE TO RELATED APPLICATIONS

This application claims the priority of Korean Patent Application No. 10-2006-0074656, filed on Aug. 8, 2006, in the Korean Intellectual Property Office, the disclosure of which is incorporated herein in its entirety by reference.

### BACKGROUND OF THE INVENTION

1. Field of the Invention

The present general inventive concept relates to a disk drive, and more particularly, to an adaptive spindle motor startup method which can control the startup of a spindle motor by adaptively adjusting a startup factor related to a startup current applied to the spindle motor corresponding to a temperature, and a disk drive using the same.

2. Description of the Related Art

Spindle motors are used in hard disk drives, CD-ROM drives, and DVD (digital versatile disk) drives. The hard disk drive rotates a disk at a target rate using a spindle motor and performs a read/write operation using a magnetic head. In this case, the drive's performance depends on it rapidly reaching the target rotation rate. Also, the disk drive needs to perform properly in extreme temperatures and/or humidity.

In general, a spindle motor can be driven by open loop control and closed loop control during startup. The closed loop control is a method of controlling a motor by detecting a back electromotive force (BEMF) generated when the motor is driven. The open loop control is a method performed before closed loop control, and used when the BEMF is not detected or is not reliably detected.

The open loop control is used to drive the motor until the BEMF reaches a predetermined value, which is usually generated reliably when the speed of the spindle motor reaches 250 to 350 rpm. During the open loop control, a unit startup pulse is repeatedly applied to the motor for a predetermined time to start the motor. In this case, an amplitude of an applying time and a repetition frequency of the unit startup pulse are set to be optimal to the room temperature and constant voltage circumstance. Thus, in conventional technology, values of the startup factors are fixed regardless of the external or internal temperature. However, the method is problematic, as described below.

First, the viscosity and frictional force of a bearing used in the spindle motor changes according to temperature, especially in a fluid dynamic bearing (FDB). Thus, when the spindle motor starts at a low temperature, the time for the spindle motor to approach the target speed increases drastically.

Second, for a contact start/stop (CSS) type drive, since the head contacts the disk when the motor starts, the frictional force increases at low temperatures, limiting the acceleration.

Third, the resistance of every device inside of a disk drive increases at high temperatures, and the performance of a permanent magnet in the spindle motor decreases. These effects adversely impact the motor torque constant and the power efficiency.

As a result, a larger current or excessive power is required to detect the BEMF in a low or high temperature environment.

To summarize, when the temperature of a disk drive changes, the mechanical and electrical parameters of its motor change, which prevents the BEMF from being reliably detected within a set or ideal timeframe. Thus, the disk drive repeatedly performs the retry operation to detect a stable BEMF, which consequently increases the motor spin-up time and adversely affects the point at which the disk drive is capable of being used.

### SUMMARY OF THE INVENTION

The present general inventive concept provides an adaptive spindle motor startup method, which uses values of factors related to startup current as variables according to temperature, so that the deterioration of the performance of the spindle motor as a result of changes in temperature is minimized and a target speed can be reliably reached during a predetermined set timeframe, and a disk drive using the same.

The present general inventive concept also provides an adaptive spindle motor startup method which uses values of factors related to startup current as variables according to a voltage, so that the deterioration of the performance of the spindle motor due to the change in the voltage is minimized and the target speed can be stably approached, and a disk drive using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an adaptive spindle motor startup method including applying an internal driving voltage to a disk drive, sensing an internal temperature of the disk drive, and controlling the startup of a spindle motor by adjusting at least one factor of a startup current applied to the spindle motor corresponding to the sensed temperature.

The startup current may be formed of a plurality of unit startup pulses and the factor is an amplitude, an applying time, or a repetition frequency of each unit startup pulse.

In the controlling of the startup of a spindle motor, when the sensed temperature is lower than a reference temperature, at least one of the amplitude, the applying time, and/or the repetition frequency is increased.

The startup may be performed by an open loop control method.

The open loop control method may include sensing an initial position of a rotor provided in the spindle motor, rotating the rotor for a unit startup time by applying the unit startup pulse to the spindle motor, sensing the position of the rotor after rotating for the unit startup time, performing repeatedly the rotating of the rotor and sensing the position of the rotor for a predetermined time, and determining whether a back electromotive force (BEMF) output from the spindle motor is equal to or greater than a predetermined value.

The sensing of the internal temperature of the disk drive may be performed by a pre-amplifier installed in the disk drive.

The determining whether a back electromotive force (BEMF) determines whether the sensing an initial position of the rotor is repeated.

The foregoing and/or other aspects and utilities of the present general inventive concept may also be achieved by providing an adaptive spindle motor startup method including applying an internal startup voltage to a disk drive, sensing an internal temperature of the disk drive, measuring an internal voltage of the disk drive, and controlling the startup of a spindle motor by adjusting at least one factor of a startup current applied to the spindle motor corresponding to the sensed temperature and the measured voltage.

The startup current may be formed of a plurality of unit startup pulses and the factor is an amplitude, an applying time, or a repetition of each unit startup pulses.

In the controlling of the startup of a spindle motor, when the measured voltage is lower than a reference voltage, at least one of the amplitude, the applying time, and the repetition frequency is increased.

The foregoing and/or other aspects and utilities of the present general inventive concept may also be achieved by providing an adaptive spindle motor startup method including storing an optimal value of a factor related to a startup current applied to a spindle motor for at least one temperature in a table, sensing an internal temperature of a disk drive, and controlling the startup of a spindle motor using the optimal value of the factor corresponding to the sensed temperature.

The temperature table may have temperature intervals of 5° C.

The storing is performed during a manufacturing process of the disk drive, but may be stored post manufacture.

The foregoing and/or other aspects and utilities of the present general inventive concept may also be achieved by providing an adaptive spindle motor startup method including storing an optimal value of a factor related to a startup current applied to a spindle motor for respective temperature periods in a first table, storing an optimal value of a factor related to the startup current applied to the spindle motor for at least one voltage in a second table, sensing an internal temperature of a disk drive, measuring an internal voltage of the disk drive, and controlling the startup of the spindle motor using the optimal value of the factor corresponding to the sensed temperature and measured voltage.

The second table can be a plurality of voltages having intervals of 0.2 V.

The foregoing and/or other aspects and utilities of the present general inventive concept may also be achieved by providing a disk drive including a spindle motor having a rotor and a stator, a spindle driver to supply a startup current to the spindle motor, a temperature sensing unit to sense a temperature of the disk drive, and a controller to adjust at least one factor of the startup current corresponding to the sensed temperature.

The startup current may be formed of a plurality of unit startup pulses and the factor is an amplitude, an applying time, or a repetition frequency of each unit startup pulse.

The startup may be performed by an open loop control method.

The temperature sensing unit may be provided in a pre-amplifier installed in the disk drive.

When the sensed temperature is lower than a reference temperature, the controller increases at least one of the amplitude, the applying time, and the repetition frequency.

The spindle motor may be a brushless DC motor or a sensorless DC motor.

The foregoing and/or other aspects and utilities of the present general inventive concept may also be achieved by providing a disk drive including a spindle motor having a rotor and a stator, a spindle driver to supply a startup current to the spindle motor, a temperature sensing unit to sense an internal temperature of the disk drive, a voltage measurement unit to measure an internal voltage of the disk drive, and a controller to adjust at least one factor of the startup current corresponding to the sensed temperature and the measured voltage.

The startup current may be formed of a plurality of unit startup pulses and the factor is an amplitude, an applying time, or a repetition frequency of each unit startup pulse.

When the measured voltage is lower than a reference temperature or/and a reference voltage, the controller increases at least one of the amplitude, the applying time, and the repetition frequency.

The foregoing and/or other aspects and utilities of the present general inventive concept may also be achieved by providing a disk drive including a spindle motor having a rotor and a stator, a spindle driver to supply a startup current to the spindle motor, a temperature sensing unit to sense a temperature of the disk drive, a memory unit storing an optimal value of a factor of a startup current for at least one temperature in a table, and a controller to adjust the startup current using the optimal value corresponding to the sensed temperature.

The memory unit includes the table comprises a plurality of temperature having temperature intervals of 5° C.

The memory unit can be a ROM (read only memory) unit, or RAM (random access memory) unit, with such a unit being a flash memory.

The foregoing and/or other aspects and utilities of the present general inventive concept may also be achieved by providing a disk drive including a spindle motor having a rotor and a stator, a spindle driver to supply a startup current to the spindle motor, a temperature to sense unit sensing an internal temperature of the disk drive, a voltage measurement unit to measure an internal voltage of the disk drive, a first memory unit to store an optimal value of a factor of startup current for at least one temperature in a first table, a second memory unit storing an optimal value of a factor of a startup current for at least one voltage in a second table, and a controller to adjust the startup current using the optimal value corresponding to the sensed temperature and the measured voltage.

The second memory unit includes the second table comprising a plurality of voltages having voltage intervals of 0.2 V.

The startup current can be limited by a predetermined maximum allowable current.

The foregoing and/or other aspects and utilities of the present general inventive concept may also be achieved by providing an adaptive spindle motor startup method including applying an internal startup voltage to a disk drive, measuring an internal factor of the disk drive, and controlling the startup of a spindle motor by adjusting at least one factor of a startup current applied to the spindle motor corresponding to the internal factor.

The internal factor may be one of a temperature or the disk drive and a voltage of a disk drive.

The foregoing and/or other aspects and utilities of the present general inventive concept may also be achieved by providing a computer-readable recording medium having a computer-readable program to perform a method, the method including applying an internal startup voltage to a disk drive, measuring an internal factor of the disk drive, and controlling the startup of a spindle motor by adjusting at least one factor of a startup current applied to the spindle motor corresponding to the internal factor.

The internal factor may be one of a temperature of the disk drive and a voltage of the disk drive or both a temperature of the disk drive and a voltage of the disk.

The foregoing and/or other aspects and utilities of the present general inventive concept may also be achieved by providing a disk drive including a spindle motor having a rotor and a stator, a spindle driver to supply a startup current to the disk drive, a sensing unit to sense at least one internal factor of the disk drive, and a controller to control the spindle motor and adjust the startup current based on the sensed internal factor.

The internal factor may be one of a temperature of the disk drive and/or a voltage of the disk drive.

The sensing device may include a plurality of sensing unit corresponding to each factor to be sensed.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a graph illustrating a startup current applied during a startup of a spindle motor;

FIG. 2 is a flow chart illustrating an operation of a startup of a spindle motor;

FIG. 3 is a view illustrating a brushless direct current (BLDC) motor used for a disk drive according to the present general inventive concept;

FIG. 4 is a graph illustrating a change of a back electromotive force (BEMF) according to temperature;

FIG. 5 is a block diagram illustrating a disk drive according to an embodiment of the present general inventive concept;

FIG. 6 is a block diagram illustrating a disk drive according to another embodiment of the present general inventive concept;

FIG. 7 is a flow chart illustrating an adaptive spindle motor startup method according to an embodiment of the present general inventive concept;

FIG. 8 is a flow chart illustrating an adaptive spindle motor startup method according to another embodiment of the present general inventive concept; and

FIG. 9 is a chart illustrating an effect of using a spindle motor startup method according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

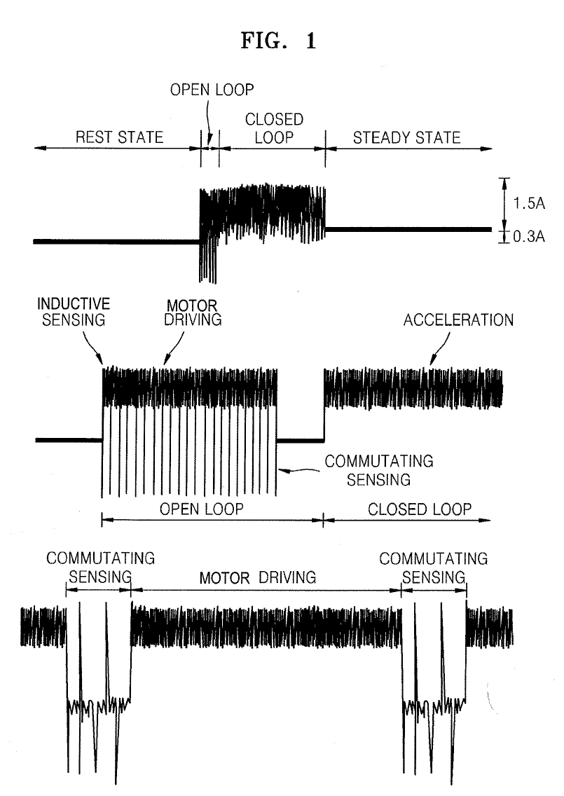

FIG. 1 is a graph illustrating a startup current applied during a startup of a spindle motor. In FIG. 1, a first graph illustrates the current applied for the startup of the spindle motor, a second graph illustrates a current applied for a spin up operation, and a third graph illustrates a current applied for an open loop operation.

Referring to the first graph of FIG. 1, no startup current is applied to the spindle motor in a rest state, and then a constant startup current is applied to rotate the spindle motor at a constant angular velocity in a spin-up period. In a steady operation state, a constant running current is applied to rotate the spindle motor at a constant speed.

The second graph of FIG. 1 illustrates the spin-up period in detail. The spin-up period includes an open loop period and a closed loop period. The open loop period includes the operations of sensing an initial position of a rotor (inductive sensing), applying a unit startup pulse to drive the motor (motor driving), and sensing a position of the rotor after unit rotation (commutation sensing). The closed loop period includes a motor accelerating and target speed operation.

In the inductive sensing operation, six voltage vectors are sequentially applied and the initial position of the rotor is sensed through a voltage change output from the spindle motor. The operation is executed for a short timeframe, for example, of 3 ms. In the motor driving operation, unit startup pulses are applied for a unit startup timeframe, for example, of 6-8 ms. In the commutation sensing operation, the accurate position of the rotor is determined for the next unit rotation for a short timeframe, for example, of 1-2 ms.

Although it is not illustrated in the drawing, after the motor driving and commutation sensing operations are performed repeatedly for a set number of repetitions, there is an operation of determining whether back electromotive force (BEMF) is detected. If no BEMF is detected during the set number of repetitions, then the drive performs a retry operation. If a BEMF is detected, the closed loop period operation of accelerating the motor speed according to the detected BEMF is performed. In this case, a maximum current is applied, for example, of 1-8-2.0 target.

Referring to the third graph of FIG. 1, the operations of motor driving and commutation sensing in the open loop period are illustrated in detail. In the motor startup period, a unit startup pulse having a constant amplitude and time is applied. The driving commutation sensing operation is similar to the inductive sensing operation.

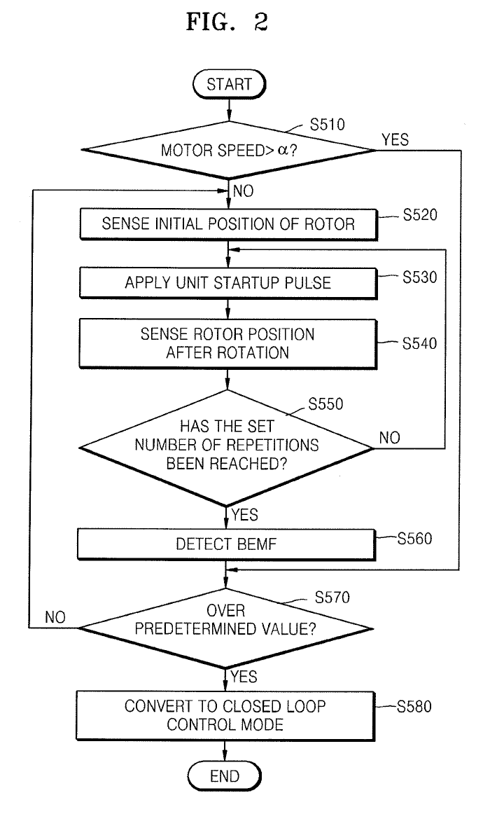

FIG. 2 is a flow chart illustrating the operation of the startup of a spindle motor. When power is supplied to the disk drive, it is determined whether the speed of the spindle motor has reached a predetermined value α operation S510. When the speed of the spindle motor exceeds the predetermined value α, it is determined whether the detected BEMF has reached a critical value. The critical value is an index indicating the reliability of the detected BEMF, and is used to determine whether an entry in the closed loop period is possible. The critical value may be very small. When a reliable level of BEMF is detected, the disk drive performs closed loop control through a phase locked loop (PLL) using the detected BEMF.

When the speed of the spindle motor is less than the predetermined value α, the disk drive senses the initial position of the rotor to perform an open loop control operation S520. A unit startup pulse is applied to unit-rotate a rotor operation S530. The position of the rotor is sensed after the unit rotation operation S540. The operations S530 and S540 form a combination and are repeated a preset number of times given operation S550. When the detected BEMF is less than the predetermined value β, and is below a reliable level per operations S560 and S570, the same open loop control is repeated beginning with the sensing initial position of rotor operation S520. Thus, the overall spindle motor startup time is increased by the open loop startup time and the number of repeats required, if any, for the BEMF to reach a predetermined value β.

When the BEMF reaches the predetermined value β, a closed loop control mode starts using the detected BEMF operation S580, and the spindle motor is accelerated until its speed reaches the target speed. Thereafter, prounital control and prounital-integral control are continuously performed so as to obtain a stable motor speed. After the target speed is reached, a running current, for example, of 0.2-0.6 A, is applied to rotate the spindle motor at a constant speed in order to compensate for the frictional force of the fluid bearing, which decreases as time passes.

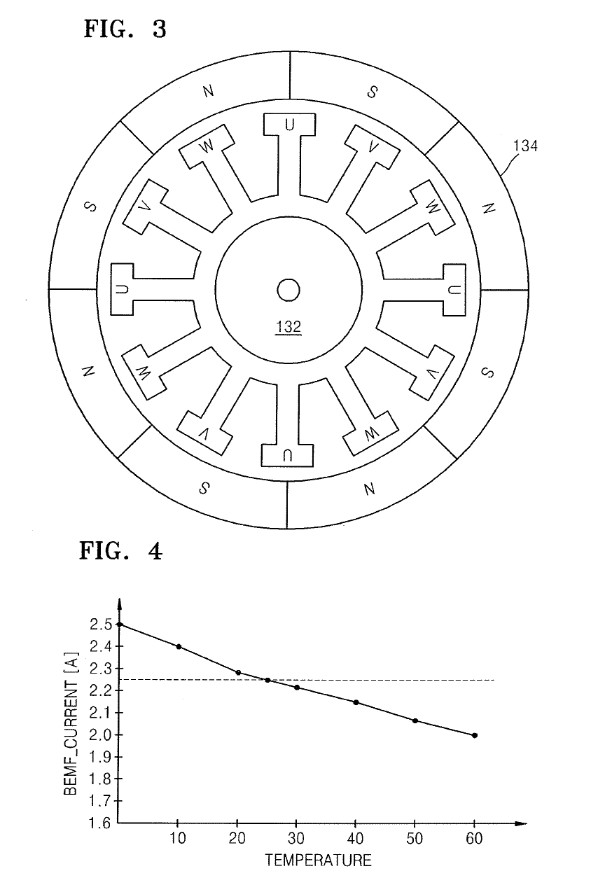

FIG. 3 is a view of a brushless direct current (BLDC) motor used for a disk drive according to an embodiment of the present general inventive concept. The BLDC motor determines the position of its rotor using a sensor such as a Hall-effect sensor or an encoder, or a sensorless method using the change in the BEMF or inductance, and the direction of current flowing at each phase. In this case, the rotor receives a rotational force by a startup torque. In the instance where a current is initially applied from a U phase to a V phase, the next current is applied from the U phase to a W phase and then from the V phase to the W phase. The above current-application operations are performed repeatedly if required.

FIG. 3 illustrates a brushless DC motor having 8 poles and 12 slots. Astator 134 has a circular permanent magnet formed of 10 magnetic poles (N poles and S poles). A rotor 132 forms a rotating magnetic field and has an armature iron core with 12 poles and slots formed and a plurality of coils (not shown) wound around the poles. The coils are divided into four groups and a voltage having a different phase such as a U, V, or W phase is applied to each of the groups.

FIG. 4 is a graph illustrating a change of BEMF according to temperature. As described above, when the temperature changes, the motor torque changes because a motor torque constant changes. Since it is difficult to directly measure the motor torque constant, the change in the motor toque constant, according to the temperature, can be indirectly predicted by measuring the BEMF.

The BEMF is obtained by measuring a current flowing in the phase of a motor when the motor driving current is zero. As illustrated in FIG. 4, the BEMF is 2.5 A at around 0° C., the BEMF is 2.25 A at around 25° C., and the BEMF is 2.0 A at around 60° C. That is, from 25° C., the BEMF increases by 9% at 0° C. and decreases by 9% at 60° C. This is prounital to the change in the torque constant. Thus, the torque constant varies according to the temperature and results in a change of the motor startup time.

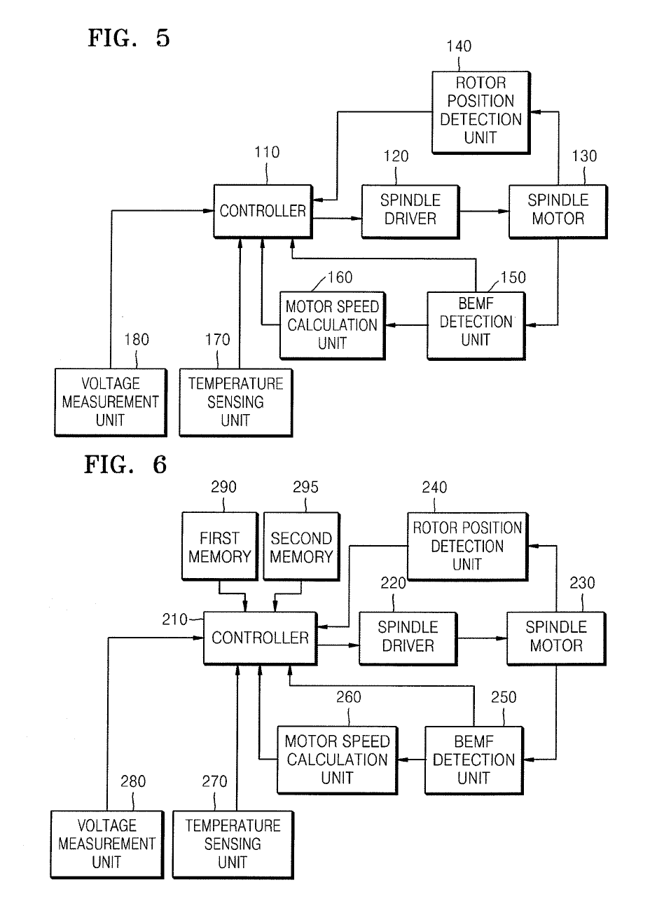

FIG. 5 is a block diagram of a disk drive according to an embodiment of the present general inventive concept. A controller 110 generates a control signal to control a spindle motor 130. A spindle driver 120 generates startup current to drive the spindle motor 130 using the control signal input from the controller 110. In the open loop control mode, a rotor position detection unit 140 senses the position of a rotor through a voltage output from the spindle motor 130 and outputs the sensed rotor position to the controller 110.

At a predetermined time after the spindle motor 130 starts rotating, a BEMF, in a sine wave, is output. A BEMF detection unit 150 receives the BEMF and outputs a phase signal. A motor speed calculation unit 160 receives the phase signal and calculates the speed of the motor. The calculated motor speed is input to the controller 110, which controls the speed of the spindle motor 130 using the motor speed.

The controller 110 can directly receive the BEMF from the BEMF detection unit 150. When the BEMF is greater than a predetermined value, the closed loop control mode starts. A temperature sensing unit 170 may be a thermistor included in a pre-amplifier unit (not shown).

The disk drive according to the present embodiment can further include a voltage measurement unit 180. In general, although the internal operation voltage is 12V, the voltage may vary according to the internal or external environment. Proper operation must be guaranteed over a voltage variation of 10%. The measured voltage is input to the controller 110.

When the disk drive is turned on, internal temperature sensing is performed by the temperature sensing unit 170. When the sensed temperature is within a predetermined range, the controller 110 controls the spindle driver 120 to generate a default startup current.

When the sensed temperature is outside the predetermined range, the controller 110 controls the spindle driver 120 to generate a startup current that is adjusted according to the temperature. Since the startup current is formed of a plurality of unit startup pulses, the startup current is controlled such that an amplitude A of an applying time B and a repetition frequency C of the unit startup pulse can be changed.

The amplitude A of the unit startup pulse can be changed according to the temperature. In general, considering only the motor, when the amplitude A of the unit startup pulse increases regardless of the temperature, the time for the motor to reach a target rotation rate can be reduced. However, the pulse increase may be limited if the disk drive is subject to a maximum allowable current, which may be predetermined.

Since the frictional force of the motor increases at low temperatures and the motor torque constant decreases at high temperatures, a greater current is required in order to obtain the same acceleration as obtained at room temperature. Thus, the disk drive according to the present embodiment can reduce power consumption by decreasing the startup current in a general environment and maintain a constant startup speed by increasing the startup current in an extreme environment.

The applying time B and repetition frequency C of the unit startup pulse can be changed according to temperature. In general, by increasing the applying time B, which indicates the time to apply a single unit startup pulse, a stable increase in motor speed can be obtained regardless of whether there is an increase in number of disks. In contrast, when the applying time B is decreased, the motor speed increase can be obtained. Also, when the repetition frequency C increases, the retry rate can be reduced as the BEMF can be easily detected.

Thus, the controller 110 can vary the amplitude A, applying time B, and repetition frequency C according to the range of a sensed temperature. For example, default values of the startup factors A, B, and C may be respectively set to 1.8 A, 6 ms, and 10 times at room temperature of 25° C. When the sensed temperature is 10° C., the controller 110 can control A, B, and C respectively to 1.8 A, 10 ms, and 15 times. That is, values of A and B are controllably increased. In the situation where the sensed temperature is lower than a reference temperature, at least one of the A, B, and C values can be increased. Accordingly, since the retry rate can be reduced, a stable open loop startup time can be obtained in a low temperature environment.

The A, B, and C values can be controlled corresponding to the sensed internal voltage of the disk drive. In general, although 12 V is supplied by a power supply to the disk drive, this voltage is not stable and may contain an error of ±10% in the output voltage, which varies from 10.8 V to 13.2 V. The variation in voltage increases the ready time and retry rate as described above. Thus, A, B, and C can be controlled corresponding to the measured internal voltage. In detail, when the measured voltage is lower than a reference voltage, at least one of the A, B, and C values is increased. It is foreseen that values of the startup factor can be controlled using the sensed temperature and/or the measured voltage.

However, it is preferred to apply the above method when the open loop startup time varies linearly according to temperature. When the open loop start time varies non-linearly according to temperature, as described below, it is preferred to store optimal values of startup factors for each temperature period in a storage medium in advance.

FIG. 6 is a block diagram of a disk drive according to another embodiment of the present general inventive concept. Referring to FIG. 6, a controller 210 generates a control signal to control a spindle motor 230. A spindle driver 220 generates startup current to drive the spindle motor 230 using the control signal input by the controller 210. A rotor position detection unit 240 senses the position of the rotor through a voltage output from the spindle motor 230 and outputs the sensed rotor position to the controller 210.

At a predetermined time after the spindle motor 230 starts rotating, a BEMF, in a sine wave, is output. A BEMF detection unit 250 receives the BEMF and outputs a phase signal. A motor speed calculation unit 260 receives the phase signal and calculates the speed of the motor. The calculated motor speed is input to the controller 210, which controls the speed of the spindle motor 230 using the motor speed.

A first memory 290 and a second memory 295 are directly connected to the controller 210. The first memory 290 stores optimal values of startup factors related to startup current for each temperature period in a table form. The second memory 295 stores optimal values of startup factors related to startup current for each voltage period in a table form.

The temperature sensed by a temperature sensing unit 270 is input to the controller 210. The controller 210 interfaces with the first memory 290 to obtain optimized values of startup factors corresponding to the sensed temperature. The controller 210 obtains data corresponding to the sensed temperature from the first memory 290 and controls the spindle driver 220 and the spindle motor 230 using the data. That is, the spindle driver 220 generates a startup current for the spindle motor 230 with the driver 220 having optimized values of startup factors according to the temperature. The temperature period in the table of the first memory 290 can have intervals of 5° C., but it is foreseen that the table may have other intervals depending on factors such as intended usage which may be affected by an application or readable media, degree of accuracy required, and/or the intended environment(s) of use, which may include general and/or extreme environments. Applications requiring especially accurate measurements may have small intervals such as 0.5° C.

The voltage measured by a voltage measurement unit 280 is input to the controller 210. The controller 210 interfaces with the second memory 295 to obtain optimized values of the startup factor corresponding to the measured voltage. The controller 210 obtains data corresponding to the measured voltage from the second memory 295 and controls the spindle driver 220 using the data. That is, the spindle driver 220 generates a startup current having startup factors having optimized values according to the voltage. The voltage period in the table of the second memory 295 can have intervals of 0.2 V, but it is foreseen that the table may have smaller or larger intervals depending on factors such as those provided above with respect to temperature.

The operation of storing the startup factor optimized for each temperature or voltage period in the first and second memories 290 and 295 is preferably performed during the disk drive manufacturing process, but may be stored post manufacture. The first and second memories 290 and 295 may be ROM (read only memory) in order to prohibit access by a user. However, since the startup factor may change, for instance as a result of a changed number of disks or spindle motor size, RAM (random access memory) such as rewritable flash memory is preferred.

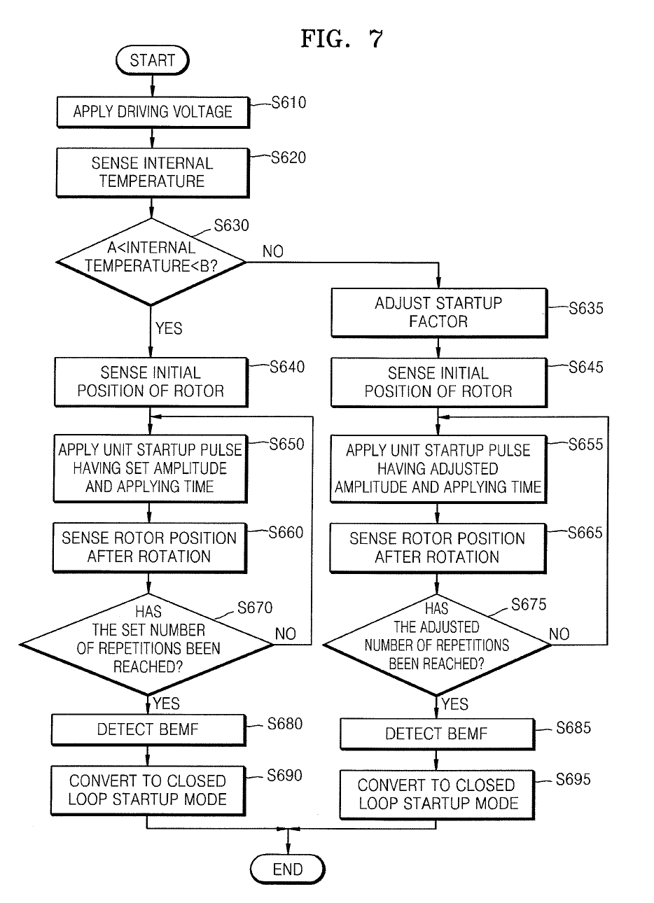

FIG. 7 is a flow chart illustrating an adaptive spindle motor startup method according to an embodiment of the present general inventive concept. Referring to FIG. 7, when the disk drive is turned on, a startup driving voltage is applied via operation S610. Next, the internal temperature of the disk drive is sensed during operation S620. The operation of sensing the temperature can be performed by a pre-amplifier installed in the disk drive.

If the sensed temperature is within a predetermined range during operation S630, the following operations are performed: rotor initial position sensing operation S640, unit startup pulse application operation S650, and rotor position after rotation sensing operation S660 are performed according to a default startup factor value. If a default repetition frequency is not reached per operation S670, the operations repeat beginning with the unit startup pulse application operation S650 and continue to repeat until the point at which the default repetition frequency is reached per S670 and/or the BEMF is detected per operation S680. Upon detection of the BEMF, the mode is changed to the closed loop startup mode operation S690. To avoid performing the retry operation at room temperature, the default startup factor can be set with a sufficient margin.

When the sensed temperature is out of a predetermined range, the startup factor(s) are adjusted per operation S635 and the following operations are performed according to the adjusted startup factor value: rotor initial position sensing operation S645, adjusted unit startup pulse application operation S655, and rotor position after rotation sensing operation S665. If an adjusted repetition frequency is not reached per operation S675, the operations repeat beginning with the adjusted unit startup pulse application operation S655 until the point at which the adjusted repetition frequency is reached per operation S675. When the set repetition frequency is reached and/or the BEMF is detected per operation S685, the mode is changed to the closed loop startup mode operation S695. The adjusted startup factor values are changed according to the sensed temperature. To avoid performing the retry operation at low temperatures, it is preferable to increase at least one of the startup factor values.

It is foreseen that an operation of measuring the internal voltage of the disk drive can be added, and/or an operation of controlling the startup of the spindle motor by adjusting the startup factor corresponding to the sensed temperature and/or measured voltage.

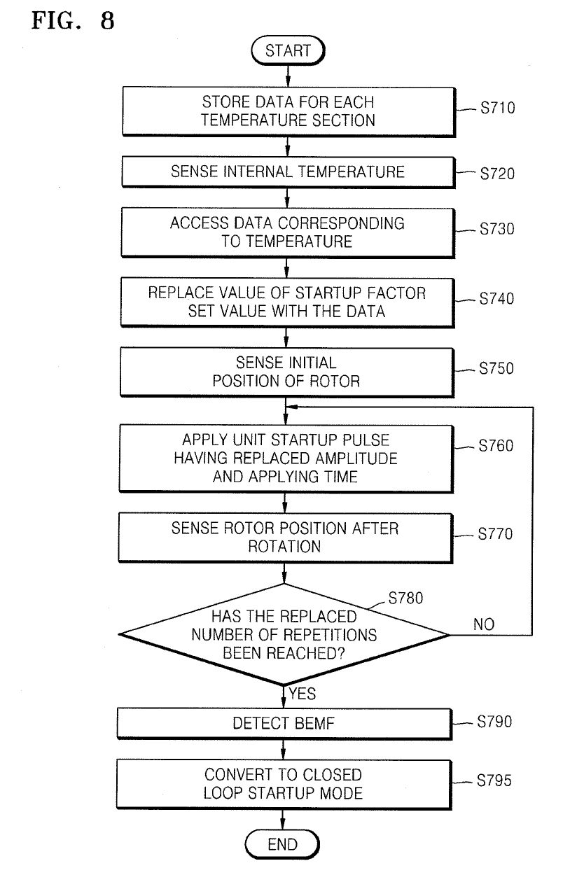

FIG. 8 is a flow chart illustrating an adaptive spindle motor startup operation according to another embodiment of the present general inventive concept. Referring to FIG. 8, startup factor values optimized for each temperature period is stored during operation S710. The temperature period may have intervals of 5° C. The optimized startup factor values can be calculated by a test at each temperature. The storing operation S710 is preferably performed during the disk drive manufacturing process, but may be stored post manufacture.

When the disk drive is turned on, the internal temperature of the disk drive is sensed during operation S720. A table having stored startup factor values corresponding to the sensed temperature is accessed per operation S730 in order to replace default startup factor values with a startup factor having new values per operation S740. The following operations are performed according to the replaced startup factor values: rotor initial position sensing operation S750, unit startup pulse application operation S760, and rotor position after rotation sensing operation S770. If a replaced repetition frequency is not reached during operation S780, the operations repeat beginning with the replaced unit startup pulse application operation S760 until the point at which the replaced repetition frequency is reached per operation S780. When the replaced repetition frequency is reached per operation S780, and/or the BEMF is detected per operation S790, the mode is changed to the closed loop startup mode operation S795.

It is foreseen that an operation of storing startup factor values optimized for each voltage period and/or an operation of measuring the internal voltage of the disk drive can be added. Also, an operation of driving the spindle motor using the optimized values of startup factor corresponding to the sensed temperature and/or measured voltage can be further added.

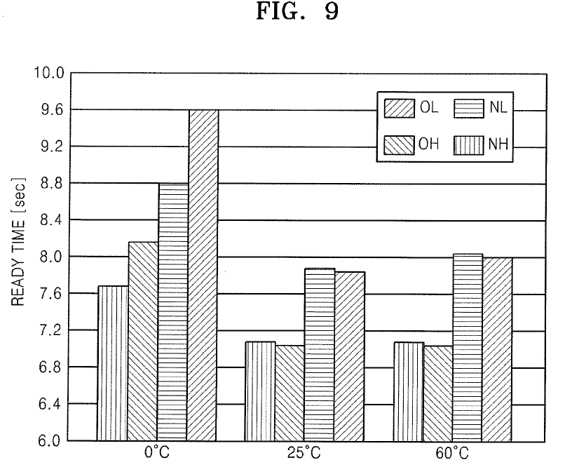

FIG. 9 is a chart illustrating the effect of using the spindle motor startup methods according to the present general inventive concept, with respect to ready time. FIG. 9 illustrates that the ready time is similar at room temperature (25° C.) and high temperature (60° C.), but is much greater at low temperature (0° C.). At a low voltage L, the ready time is 9.6 seconds when using a spindle motor startup method not using a factor sensing unit (OL), but the ready time is 8.8 seconds when using a spindle motor startup method using a factor sensing unit (NL). At a high voltage H, the ready time is 8.2 seconds when using a spindle motor startup method not using a factor sensing unit (OH), but the ready time is 7.7 second when using a spindle motor startup method using a factor sensing unit (NH). Thus, when the disk drive is operated at a low temperature, the target rotation rate can be reached faster by applying the spindle motor startup method using a factor sensing unit according to the present general inventive concept.

Various embodiments of the present generally inventive concept can be embodied as computer readable codes on a computer readable recording medium. The computer readable recording medium may include any data storage device suitable to store data that can be read by a computer system. A non-exhaustive list of possible examples of computer readable recording mediums include read-only memory (ROM), random-access memory (RAM), CD-ROMS, magnetic tapes, floppy disks, optical storage devices, and carrier waves, such as data transmission via the internet. The computer readable recording medium may also be distributed over network-coupled computer systems so that the computer readable code is stored and executed in a distribution fashion. Various embodiments of the present general inventive concept may also be embodied in hardware, software or in a combination of hardware and software.

As described above, the spindle motor startup methods according to the present general inventive concept and the disk drive using the methods can achieve a stable spin-up time regardless of changes in temperature and/or voltage, thus improving the startup performance of the motor. Also, when a thermistor included in a pre-amplifier is used as the temperature sensing unit, the cost and size can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An adaptive spindle motor startup method, the method comprising:
applying an internal driving voltage to a disk drive;
sensing an internal temperature of the disk drive; and
controlling the startup of a spindle motor by adjusting at least one factor of a startup current applied to the spindle motor corresponding to the sensed temperature.

2. The method of claim 1, wherein the startup current is formed of a plurality of unit startup pulses and the factor is an amplitude, an applying time, or a repetition frequency of each unit startup pulse.

3. The method of claim 2, wherein the controlling of the startup comprises increasing at least one of the amplitude, the applying time, and the repetition frequency when the sensed temperature is lower than a reference temperature.

4. The method of claim 1, wherein the startup is performed by an open loop control method.

5. The method of claim 4, wherein the open loop control method comprises:
sensing an initial position of a rotor provided in the spindle motor;
rotating the rotor for a unit startup time by applying a unit startup pulse to the spindle motor;
sensing a position of the rotor after rotating for the unit startup time;
performing repeatedly the rotating of the rotor and sensing the position of the rotor for a predetermined time; and
determining whether a back electromotive force (BEMF) output from the spindle motor is equal or greater than a predetermined value.

6. The method of claim 1, wherein the sensing of the internal temperature of the disk drive is performed by a pre-amplifier installed in the disk drive.

7. An adaptive spindle motor startup method, the method comprising:
applying an internal startup voltage to a disk drive;
sensing an internal temperature of the disk drive;
measuring an internal voltage of the disk drive; and
controlling the startup of a spindle motor by adjusting at least one factor of a startup current applied to the spindle motor corresponding to the sensed temperature and the measured voltage.

8. The method of claim 7, wherein the startup current is formed of a plurality of unit startup pulses and the factor is an amplitude, an applying time, or a repetition of each unit startup pulse.

9. The method of claim 8, wherein the controlling of the startup of a spindle motor comprises increasing at least one of the amplitude, the applying time, and the repetition frequency when at least one of the sensed temperature and the measured voltage is lower than a reference temperature or/and a reference voltage.

10. An adaptive spindle motor startup method, the method comprising:
storing an optimal value of a factor of a startup current applied to a spindle motor for at least one temperature in a table;
sensing an internal temperature of a disk drive; and
controlling the startup of a spindle motor using the optimal value of the factor corresponding to the sensed temperature.

11. The method of claim 10, wherein the table comprises a plurality of temperatures having temperature intervals of 5° C.

12. The method of claim 10, wherein the storing is performed during a manufacturing process of the disk drive.

13. An adaptive spindle motor startup method, the method comprising:
storing an optimal value of a factor related to a startup current applied to a spindle motor for at least one temperature in a first table;
storing an optimal value of a factor related to the startup current applied to the spindle motor for at least one voltage in a second table;
sensing an internal temperature of a disk drive;
measuring an internal voltage of the disk drive; and
controlling the startup of the spindle motor using the optimal value of the factor corresponding to the sensed temperature and measured voltage.

14. The method of claim 13, wherein the second table comprises a plurality of voltages having voltage intervals of 0.2 V.

15. A disk drive comprising:
a spindle motor having a rotor and a stator;
a spindle driver to supply a startup current to the spindle motor;
a temperature sensing unit to sense a temperature of the disk drive; and
a controller to adjust at least one factor of the startup current corresponding to the sensed temperature.

16. The disk drive of claim 15, wherein the startup current is formed of a plurality of unit startup pulses and the factor is an amplitude, an applying time, or a repetition frequency of each unit startup pulse.

17. The disk drive of claim 15, wherein the startup is performed by an open loop control method.

18. The disk drive of claim 15, wherein the temperature sensing unit is provided in a pre-amplifier installed in the disk drive.

19. The disk drive of claim 16, wherein the controller increases at least one of the amplitude, the applying time, and the repetition frequency when the sensed temperature is lower than a reference temperature.

20. The disk drive of claim 15, wherein the spindle motor is a brushless DC motor.

21. The disk drive of claim 15, wherein the spindle motor is a sensorless DC motor.

22. A disk drive comprising:
a spindle motor having a rotor and a stator;
a spindle driver to supply a startup current to the spindle motor;
a temperature sensing unit to sense an internal temperature of the disk drive;
a voltage measurement unit to measure an internal voltage of the disk drive; and
a controller to adjust at least one factor of the startup current corresponding to the sensed temperature and the measured voltage.

23. The disk drive of claim 22, wherein the startup current is formed of a plurality of unit startup pulses and the factor is an amplitude, an applying time, or a repetition frequency of each unit startup pulse.

24. The disk drive of claim 23, wherein the controller increases at least one of the amplitude, the applying time, and the repetition frequency when at least one of the sensed temperature and the measured voltage is lower than a reference temperature or/and a reference voltage.

25. A disk drive comprising:
a spindle motor having a rotor and a stator;
a spindle driver to supply a startup current to the spindle motor;
a temperature sensing unit to sense a temperature of the disk drive;
a memory unit to store an optimal value of a factor of a startup current for at least one temperature in a table; and
a controller to adjust the startup current using the optimal value corresponding to the sensed temperature.

26. The disk drive of claim 25, wherein the memory unit includes the table comprises a plurality of temperatures having temperature intervals of 5° C.

27. The disk drive of claim 25, wherein the memory unit is a ROM (read only memory).

28. The disk drive of claim 25, wherein the memory unit is a flash memory.

29. A disk drive comprising:
a spindle motor having a rotor and a stator;
a spindle driver to supply a startup current to the spindle motor;
a temperature sensing unit to sense an internal temperature of the disk drive;
a voltage measurement unit to measure an internal voltage of the disk drive;
a first memory unit to store an optimal value of a factor of a startup current for at least one temperature in a first table;
a second memory unit to store an optimal value of a factor of a startup current for at least one voltage in a second table; and
a controller to adjust the startup current using the optimal value corresponding to the sensed temperature and the measured voltage.

30. The disk drive of claim 29, wherein the second memory unit includes the second table comprises a plurality of voltages having voltage intervals of 0.2 V.

31. The disk drive of claim 29, wherein the startup current is limited by a predetermined maximum allowable current.

32. An adaptive spindle motor startup method, comprising:
applying an internal startup voltage to a disk drive;
measuring at least one internal factor of the disk drive; and
controlling the startup of a spindle motor by adjusting at least one factor of a startup current applied to the spindle motor corresponding to the internal factor.

33. The method of claim 32, wherein the internal factor is one of a temperature of the disk drive and a voltage of the disk drive.

34. The method of claim 32, wherein the internal factor is a temperature of the disk drive and a voltage of the disk drive.

35. A computer-readable recording medium having a computer-readable program to perform a method, the method comprising:
applying an internal startup voltage to a disk drive;
measuring an internal factor of the disk drive; and
controlling the startup of a spindle motor by adjusting at least one factor of a startup current applied to the spindle motor corresponding to the internal factor.

36. The computer-readable recording medium of claim 35, wherein the internal factor is one of a temperature of the disk drive and a voltage of the disk drive.

37. A disk drive comprising:
a spindle motor having a rotor and a stator;
a spindle driver to supply a startup current to the disk drive;
a sensing unit to sense at least one internal factor of the disk drive; and
a controller to control the spindle motor and adjust the startup current based on the sensed internal factor.

38. The method of claim 37, wherein the internal factor is one of a temperature of the disk drive and a voltage of the disk drive.

39. The method of claim 37, wherein the sensing unit includes a plurality of sensing device corresponding to each factor to be sensed.
